(19) United States
(12) Patent Application Publication
(10) Pub. No.: US 2014/0185270 A1
(43) Pub. Date: Jul. 3, 2014

(54) LIGHTING STRUCTURE AND ILLUMINATING DEVICE

(71) Applicant: GENESIS PHOTONICS INC., Tainan City (TW)

(72) Inventors: Cheng-Yen Chen, Tainan City (TW); Sheng-Yuan Sun, Tainan City (TW); Kuan-Wen Chen, Tainan City (TW); Jeng-Jie Huang, Tainan City (TW); Chih-Ming Chen, Tainan City (TW)

(73) Assignee: GENESIS PHOTONICS INC., Tainan City (TW)

(21) Appl. No.: 14/138,519

(22) Filed: Dec. 23, 2013

(30) Foreign Application Priority Data
Dec. 28, 2012 (TW) 101151169

(51) Int. Cl. F21K 99/00

(52) U.S. Cl. CPC F21K 9/50; F21K 9/56
USPC 362/84; 362/311.02

(57) ABSTRACT

A lighting structure includes a substrate, a light emitting diode, a cover unit, and a hollow column. The substrate has a top surface and a rear surface opposite to the top surface. The light emitting diode is disposed on the top surface and is electrically connected to the substrate. The cover unit is disposed on and cooperates with the substrate to define a receiving space in which the light emitting diode is disposed. The hollow column is connected to the rear surface of the substrate and extends in a vertical direction away from the rear surface. The cover unit and the hollow column respectively have a height in the vertical direction, and the height of the hollow column is 2 times to 10 times the height of the cover unit.

### CROSS-REFERENCE TO RELATED APPLICATION

This application claims priority of Taiwanese Patent Application No. 101151169, filed on Dec. 28, 2012.

### BACKGROUND OF THE INVENTION

1. Field of the Invention

The invention relates to a lighting structure and an illuminating device including the same.

2. Description of the Related Art

An illuminating device nowadays not only provides light in the dark, but is also used for decoration and for warning.

A candle is usually used for worship in a temple or for creating ambiance. However, the candle light is easily extinguished by environment factors, e.g., wind. Moreover, when the candle has burned out, it needs to be replaced by a new one. Thus, use of the candle is somewhat inconvenient and may cause air pollution and/or a fire accident.

In order to overcome the above shortcomings, a candle-like illuminating device 1 has been proposed. Referring to FIG. 1, the candle-like illuminating device 1 includes a light holder 11, a lighting structure 12 disposed on the light holder 11, a light guide unit 13, and a shell 14 disposed on the light holder 11.

The light holder 11 includes a holding plate 111 and an electrical terminal 112 that is disposed away from the holding plate 111 and that is configured for electrical connection to an external power source. The holding plate 111 has a top surface 113 and a bottom surface 114 opposite to the top surface 113. The lighting structure 12 and the light guide unit 13 are disposed on the top surface 113 of the holding plate 111. The shell 14 is disposed on the light holder 11 and encloses the lighting structure 12 and the light guide unit 13.

The lighting structure 12 includes a base 21 disposed on the top surface 113 of the holding plate 111, at least one light emitting diode (LED) 22 disposed in and electrically connected to the base 21, and an encapsulant 23 enclosing the LED 22 to protect the LED 22 from being damaged. It is noted that the LED 22 is chosen due to its high brightness and energy saving characteristics.

Referring to FIG. 2, the base 21 has a leg unit 212 that is electrically connected to the electrical terminal 112 of the light holder 11 and to the LED 22, so that external power can be provided to the LED 22 through the light holder 11 and the base 21.

To simulate the candle light, the light emitted from the LED 22 is guided to a predetermined position by the light guide unit 13 disposed on the lighting structure 12 to form a virtual light source 100 (see FIG. 1). In the related art, research has mainly focused on the development of the structure of the light guide unit 13 in the candle-like illuminating device, so as to provide superior light-extraction efficiency and more concentrated and uniform luminous ability.

In addition, the lighting structure 12 is made to have a structure as shown in FIG. 2 for concentrating forward light-extraction efficiency. To be specific, the base 21 is in a substantial bowl shape with a flat bottom portion and has a curved inner surface 211 having a reflecting property and defining a packaging space 210. The light from the LED 22 is reflected to an upper opening of the base 21 by the reflective curved inner surface 211.

The packaging space 210 is filled with the encapsulant 23 to completely enclose and protect the LED 22 disposed in the packaging space 210. The encapsulant 23 is made of a polymer material having superior optical property such as resin. Furthermore, the encapsulant 23 may be added with fluorescent powders to adjust the illuminating color.

The light guide unit 13 is mainly made of a polymer material (e.g., acrylic plastic). Since the encapsulant 23 and the light guide unit 13 are both made of the polymer material, the heat resistance thereof is inferior and a photoyellowing problem would occur that may reduce the illuminating efficiency. Moreover, the fluorescent powders in the encapsulant 23 are liable to decay due to heat, thereby resulting in uneven illuminating color and undesired color tone change.

### SUMMARY OF THE INVENTION

Therefore, a first object of the present invention is to provide a lighting structure having superior thermal conductivity, high luminous efficiency, and long service life.

A second object of the present invention is to provide an illuminating device including the aforesaid lighting structure.

According to a first aspect of this invention, there is provided a lighting structure that includes a substrate, a light emitting diode, a cover unit, and a hollow column. The substrate has a top surface and a rear surface opposite to the top surface. The light emitting diode is disposed on the top surface of the substrate and is electrically connected to the substrate. The cover unit is disposed on the substrate and cooperates with the substrate to define a receiving space in which the light emitting diode is disposed. The hollow column is connected to the rear surface of the substrate and extends in a vertical direction away from the rear surface. The cover unit and the hollow column respectively have a height in the vertical direction, and the height of the hollow column is 2 times to 10 times the height of the cover unit.

According to a second aspect of this invention, there is provided an illuminating device that includes a light holder, a lighting structure, and a shell. The light holder includes a holding plate and an electrical terminal configured for electrical connection to an external power source. The lighting structure is disposed on the light holder and includes a substrate, a light emitting diode, a cover unit, and a hollow column. The substrate has a top surface and a rear surface opposite to the top surface. The light emitting diode is disposed on the top surface of the substrate and is electrically connected to the substrate. The cover unit is disposed on the substrate and cooperates with the substrate to define a receiving space in which the light emitting diode is disposed. The hollow column is connected to the rear surface of the substrate and extends in a vertical direction away from the rear surface. The shell is disposed on the light holder and encloses the lighting structure. The cover unit and the hollow column respectively have a height in the vertical direction, and the height of the hollow column is 2 times to 10 times the height of the cover unit.

### BRIEF DESCRIPTION OF THE DRAWINGS

Other features and advantages of the present invention will become apparent in the following detailed description of the preferred embodiments with reference to the accompanying drawings, of which:

FIG. 1 is a cross-sectional view of a conventional illuminating device;

FIG. 2 is a cross-sectional view illustrating a lighting structure of the conventional illuminating device;

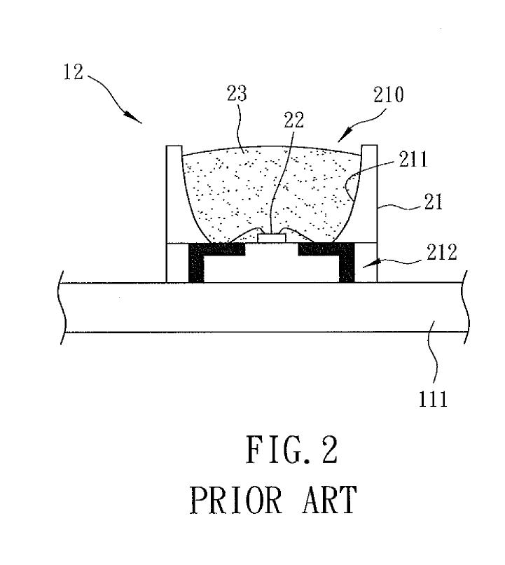

FIG. 3 is a cross-sectional view of a first preferred embodiment of an illuminating device according to this invention;

FIG. 4 is a cross-sectional view to illustrate a lighting structure of the first preferred embodiment;

FIG. 5 is a cross-sectional view illustrating a modification of the lighting structure of the first preferred embodiment; and

FIG. 6 is a cross-sectional view of a second preferred embodiment of an illuminating device according to this invention.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the following disclosure.

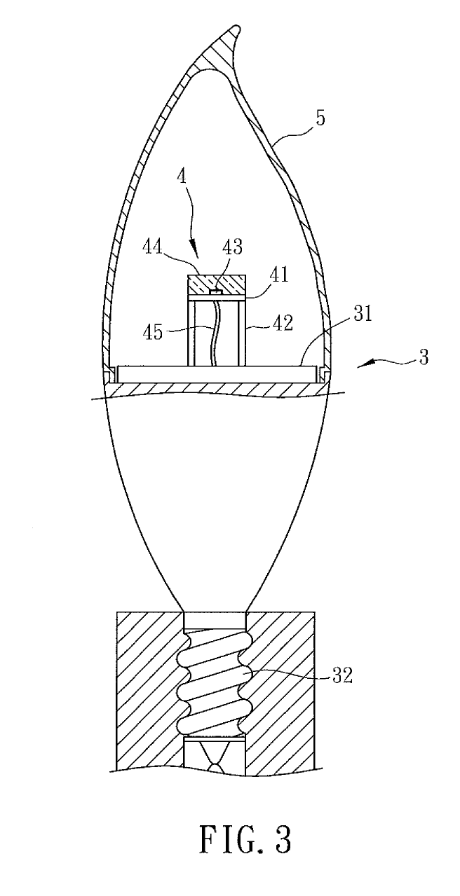

Referring to FIG. 3, an illuminating device of the first preferred embodiment according to this invention includes a light holder 3, a lighting structure 4, and a shell 5.

The light holder 3 includes a holding plate 31 on which the lighting structure 4 is disposed, and an electrical terminal 32 configured for electrical connection to an external power source.

The shell 5 is disposed on one side of the holding plate 31 of the light holder 3 to enclose the lighting structure 4. The electrical terminal 32 is disposed on the other side of the holding plate 31 oppositely of the shell 5. The light holder 3 and the shell 5 cooperate to define a profile of the illuminating device and enclose and protect the lighting structure 4.

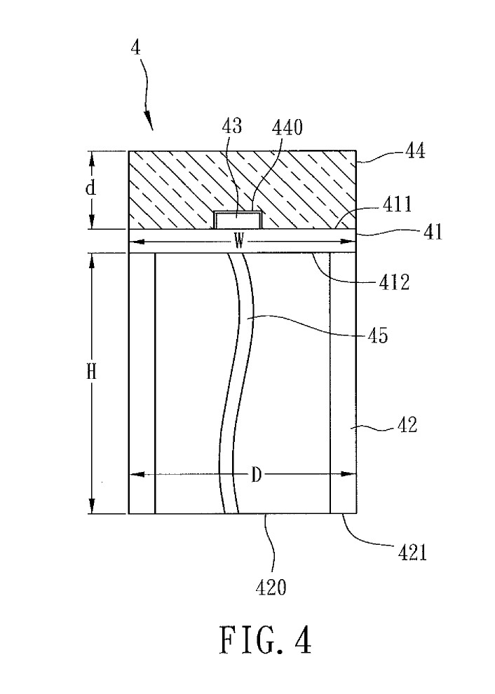

The lighting structure 4 is disposed on the light holder 3 and, preferably, has a matchstick appearance. Referring to FIG. 4, the lighting structure 4 includes a substrate 41, a hollow column 42, at least one light emitting diode 43 as a light source, a cover unit 44, and an electrical wire 45. The substrate 41 has a top surface 411 and a rear surface 412 opposite to the top surface 411. The hollow column 42 is disposed on the holding plate 31, is connected to the rear surface 412 of the substrate 41, and extends in a vertical direction away from the rear surface 412 so as to separate the substrate 41 and the holding plate 31. The light emitting diode 43 is disposed on the top surface 411 of the substrate 41 and is electrically connected to the substrate 41. In the first preferred embodiment, the light emitting diode 43 is disposed on the top surface 411 of the substrate 41 by flip chip connection, so that the space and costs for gold wire bonding could be saved and the uniformity of illumination could be enhanced.

The hollow column 42 has a bottom surface 421 opposite to the rear surface 412 of the substrate 41, and is formed with an opening 420 in the bottom surface 421. The electrical wire 45 is disposed in the hollow column 42 and passes through the opening 420 of the hollow column 42 to electrically connect to the electrical terminal 32 of the light holder 3. The electrical wire 45 is also electrically connected to the light emitting diode 43 of the lighting structure 4. In other words, one end of the electrical wire 45 electrically connects to the substrate 41, and the other end of the electrical wire 45 passes through the opening 420 to electrically connect to the electrical terminal 32 of the light holder 3. Thus, an electrical conductive path is formed. External electric power is transmitted from the electrical terminal 32 of the light holder 3, the electrical wire 45, and the substrate 41 to the light emitting diode 43 through the electrical conductive path so as to provide electric power to the substrate 41 and the light emitting diode 43.

Since heat will be generated when the light emitting diode 43 emits light, the hollow column 42 is preferably made of a material having good thermal conductivity and heat dissipation efficiency. Examples of the material for the hollow column 42 include aluminum, tin, copper, silver, gold, and combinations thereof. Aluminum is selected to serve as the material for the hollow column 42 in the first preferred embodiment. In the first preferred embodiment, the hollow column 42 is in a cylinder shape. However, in practice, the hollow column 42 may be in a polygonal column shape to increase the heat dissipation efficiency. Hence, in this preferred embodiment, the hollow column 42 is not only used to elevate the light emitting diode 43 to a predetermined position without using a conventional light guide unit, but is also used to provide superior heat dissipation efficiency, thereby increasing the illuminating efficiency.

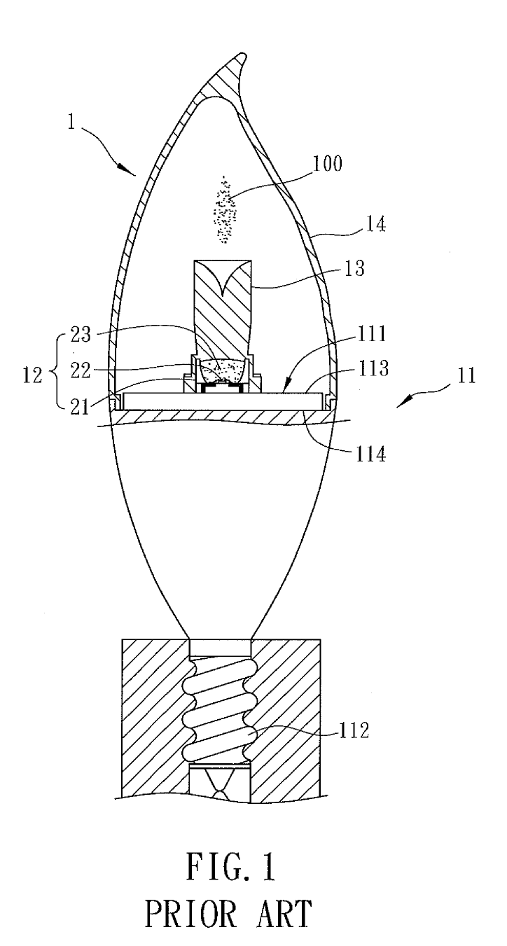

To be specific, the conventional light guide unit 13 as shown in FIG. 1 is used for multiple reflection and refraction of light from the light emitting diode 22 so as to guide the light to the predetermined position so as to simulate the candle light. However, a part of light is likely to be refracted out of the conventional light guide unit 13 so that light concentrating efficiency and illuminating efficiency may be reduced, and the desired light shape may not be obtained. In this invention, the hollow column 42 is used to elevate the light emitting diode 43 so as to accurately control the position of the light source. Additionally, the hollow column 42 could be used to dissipate heat generated by the light emitting diode 43 so as to increase the heat dissipation effect.

The cover unit 44 is disposed on the top surface 411 of the substrate 41 and cooperates with the substrate 41 to define a receiving space 440 in which the light emitting diode 43 is disposed. The cover unit 44 is made of a silicon dioxide-based material or an aluminum oxide-based material. Preferably, the cover unit 44 is made of the silicon dioxide-based material. Silicon dioxide (i.e., glass) has good optical, electrical insulating and heat dissipating properties, rigid structure, and good chemical inertness. As such, the cover unit 44 made of silicon dioxide could be used to replace the encapsulant 23 made of a polymer material so as to provide superior protection for the light emitting diode 43. Therefore, the light emitting diode 43 is not liable to be deteriorated due to the external environment.

Since the cover unit 44 made of silicon dioxide has good thermal conductivity and heat dissipation efficiency, the space between the light emitting diode 43 and the cover unit 44 is preferably as small as possible. More preferably, the receiving space 440 has a size substantially the same as a size of the light emitting diode 43 so that the heat generated from the light emitting diode 43 could be dissipated quickly.

Referring to FIG. 4, the hollow column 42 and the cover unit 44 respectively have a height (H) and (d) in the vertical direction, and the height of the hollow column (H) is 2 times to 10 times the height of the cover unit (d), so that the profile of the lighting structure 4 is similar to a matchstick so as to obtain light simulating candle light. The heat generated by the light emitting diode 43 would be transmitted outwardly through the hollow column 42 to achieve better heat dissipation efficiency. Preferably, the height (d) of the cover unit 44 ranges from 0.5 cm to 2.0 cm, and the height (H) of the hollow column 42 ranges from 1.0 cm to 4.0 cm.

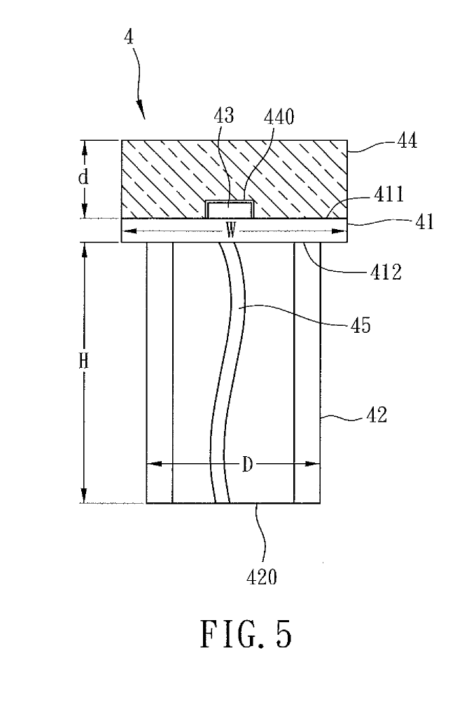

In FIG. 4, the substrate 41 has a width (W) and the hollow column 42 has a maximum diameter (D). The maximum diameter (D) of the hollow column 42 is the same as the width (W) of the substrate 41. Alternatively, as shown in FIG. 5, the maximum diameter (D) of the hollow column 42 may be less than the width (W) of the substrate 41. Preferably, the width (W) of the substrate 41 is 1 time to 3 times the maximum diameter (D) of the hollow column 42. Considering stability of the structure, the width (W) should not be greater than 3 times the maximum diameter (D) to prevent unsteadiness of the illuminating device. Therefore, considering illuminating area, light emitting angle, and heat dissipation, the lighting structure preferably has the matchstick profile.

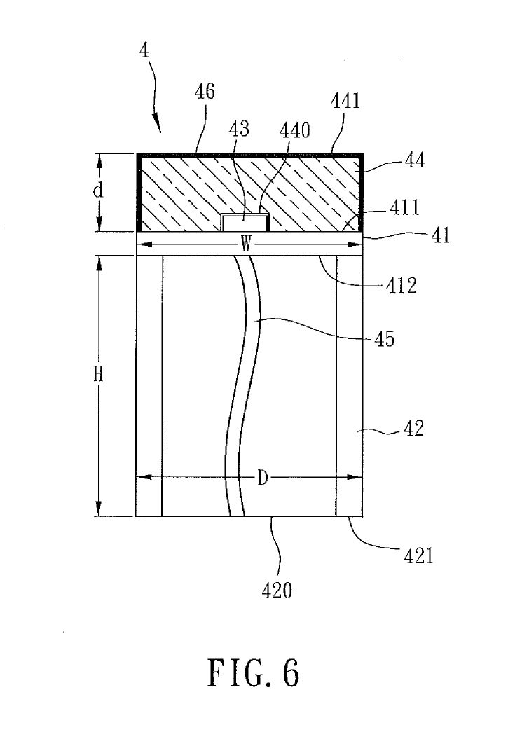

Referring to FIG. 6, the second preferred embodiment of the illuminating device of this invention is similar to the first preferred embodiment, except that the lighting structure 4 further includes a fluorescent layer 46 formed on the cover unit 44. To be specific, the cover unit 44 further has an outer surface 441 disposed away from the light emitting diode 43, and the fluorescent layer 46 is formed on the outer surface 441 of the cover unit 44 so as to provide light with a different wavelengths and color.

Moreover, since the fluorescent layer 46 is disposed on the outer surface 441 of the cover unit 44 and is spaced apart from the light emitting diode 43, and since the cover unit 44 is made of the silicon dioxide-based material with good thermal conductivity and heat dissipation efficiency, the adverse influence of heat generated by the light emitting diode 43 on the fluorescent layer 46 may be reduced, thereby attenuating the degradation of the fluorescent layer 46.

To sum up, with the inclusion of the hollow column 42 in this invention, the position of the light source (i.e., light emitting diode 43) can be elevated so as to increase the illuminating area and the light emitting angle. Moreover, the hollow column 42 would provide superior heat dissipation efficiency for the illuminating device. The cover unit 44 made of silicon dioxide-based material provides good protection for the light emitting diode 43.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A lighting structure, comprising:
a substrate having a top surface and a rear surface opposite to said top surface;
a light emitting diode disposed on said top surface of said substrate and electrically connected to said substrate;
a cover unit disposed on said substrate and cooperating with said substrate to define a receiving space in which said light emitting diode is disposed; and
a hollow column connected to said rear surface of said substrate and extending in a vertical direction away from said rear surface;
wherein said cover unit and said hollow column respectively have a height in the vertical direction, the height of said hollow column being 2 times to 10 times the height of said cover unit.

2. The lighting structure according to claim 1, wherein said cover unit is made of a silicon dioxide-based material.

3. The lighting structure according to claim 1, further comprising a fluorescent layer that is formed on an outer surface of said cover unit.

4. The lighting structure according to claim 1, wherein said light emitting diode is disposed on said top surface of said substrate by flip chip connection.

5. The lighting structure according to claim 1, wherein said receiving space has a size substantially the same as a size of said light emitting diode.

6. The lighting structure according to claim 1, wherein said hollow column is made of a material selected from the group consisting of aluminum, tin, copper, silver, gold, and combinations thereof.

7. The lighting structure according to claim 1, wherein said rear surface of said substrate has a width (W) and said hollow column has a maximum diameter (D), and said width (W) of said substrate is 1 time to 3 times said maximum diameter (D) of said hollow column.

8. The lighting structure according to claim 1, wherein said hollow column is in a cylinder shape, has a bottom surface opposite to said rear surface, and is formed with an opening in said bottom surface.

9. The lighting structure according to claim 8, further comprising an electrical wire disposed in said hollow column, electrically connected to said substrate, and passing through said opening of said hollow column for connecting an external power source.

10. An illuminating device, comprising:
a light holder including a holding plate and an electrical terminal configured for electrical connection to an external power source;
a lighting structure disposed on said light holder, said lighting structure including:
a substrate having a top surface and a rear surface opposite to said top surface;
a light emitting diode disposed on said top surface of said substrate and electrically connected to said substrate;
a cover unit disposed on said substrate and cooperating with said substrate to define a receiving space in which said light emitting diode is disposed; and
a hollow column connected to and extending in a vertical direction away from said rear surface of said substrate; and
a shell disposed on said light holder and enclosing said lighting structure;
wherein said cover unit and said hollow column respectively have a height in the vertical direction, the height of said hollow column being 2 times to 10 times the height of said cover unit.

11. The illuminating device according to claim 10, wherein said cover unit is made of a silicon dioxide-based material.

12. The illuminating device according to claim 10, wherein said lighting structure further includes a fluorescent layer that is formed on an outer surface of said cover unit.

13. The illuminating device according to claim 10, wherein said light emitting diode is disposed on said top surface of said substrate by flip chip connection.

14. The illuminating device according to claim 10, wherein said receiving space has a size substantially the same as a size of said light emitting diode.

15. The illuminating device according to claim 10, wherein said hollow column is made of a material selected from the group consisting of aluminum, tin, copper, silver, gold, and combinations thereof.

16. The illuminating device according to claim 10, wherein said rear surface of said substrate has a width (W) and said hollow column has a maximum diameter (D) and said width (W) of said substrate is 1 time to 3 times said maximum diameter (D) of said hollow column.

17. The illuminating device according to claim 10, wherein said hollow column is in a cylinder shape, has a bottom surface opposite to said rear surface, and is formed with an opening in said bottom surface.

18. The illuminating device according to claim 17, wherein said lighting structure further includes an electrical wire disposed in said hollow column, electrically connected to said substrate, and passing through said opening of said hollow column to electrically connect to said electrical terminal of said light holder.
